(19) United States
(12) Patent Application Publication
(10) Pub. No.: US 2007/0255651 A1
(43) Pub. Date: Nov. 1, 2007

(54) Batch processing of financial transactions

(75) Inventor: Karsten Egetoft, Wiesloch (DE)

Correspondence Address: KENYON & KENYON LLP, ONE BROADWAY, NEW YORK, NY, 10004, US

(73) Assignee: SAP AKTIENGESELLSCHAFT

(21) Appl. No.: 11/414,109

(22) Filed: Apr. 28, 2006

(51) Int. Cl. G06Q 40/00

(52) U.S. Cl. 705/39

(57) ABSTRACT

Batch processing of financial transactions includes collecting a plurality of payments, such as credit or debit payments, in a payment system. The payments are sorted with the credit payments being sorted to a credit bundle. The debit payments are submitted to a simulated posting in an account management system. If the debit payment would be accepted, the debit payment is added to a debit bundle. Thereupon, the credit bundle is processed as a single transaction in the account management system. The payment system verifies that an account associated with the debit bundle has the financial reserves to cover the debit bundle amount. If the reserve is not available, the payment system removes debit payments until the reserve covers the debit bundle. The debit bundle is then processed as a single transaction in the account management system.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to electronically processing financial transactions and more specifically to improving batch processing techniques for processing a plurality of related electronic payments as a single transaction.

In processing systems relating to financial transactions, one common advantage is batch processing operations. These operations allow for the consolidation of a large number of financial transactions to a similar account. For example, if a business receives a large number of deposits to a payment account, it can be onerous to process each payment individually. In one example, a business such as an electrical utility company may have monthly bill payments from the large number of utility customers. The business receives a significant volume of checks or other types of payments on a daily basis, for example credit or electronic debt transactions. These payments are collected by the financial institution that is servicing the account of the business.

In previous systems, each payment presented to the financing institution would need to be individually processed, which is not only time consuming but also complicated for the accounting system recording and maintaining the large number of payment entries. In existing batch processing systems, similar payments are bundled together for a single payment. Using the example of a utility company, the financial institution may compile all of the day's payments into a single batch. This batch, containing anywhere from a couple to hundreds to potentially thousands of payments, is then presented to the business in a single batch which contains the details of each single payment.

If the financial institution were to process several thousand payments on any single day, batch processing would allow for those single payments to be processed as a single one-time batch payment. This one-time payment would be recorded in the accounting system as a single data entry field.

The existing batch processing techniques can be problematic when there are issues with one or more of the payments included in the batch. While the batch itself may include an itemized list of payments, the accounting system processes the batch in a single transaction.

For example, one common problem with a debit payment to the account of the business may be insufficient funds on the account of the business. If the business is issuing checks to pay bills and the debit entries on their account are processed within a batch the financial institution should not cash the checks there is not enough funds on the account of the business when the checks are presented to the bank. In common parlance, the check will bounce because the bank will not honor the check. In this scenario, the bank takes a risk if due to the batch processing of multiple checks each check is not checked against the available amount on the account before the check is accepted and processed within the batch. The bank risks that it will cash checks where there are no funds available. This could potentially cause a loss if the business is not able to cover the overdraft.

In another example, a business might have placed a hold or other type of restriction on the payment. For example, in common parlance there might be a stop-payment placed on the check itself. In this case, the payment will be erroneously processed as part of the batch. As in the above case, because the payment has been initially processed without a detection of problems associated with the payment, the bank will have to offer credit to the business to cover the processed check that should have been blocked.

It is commonplace for the existing systems in financial institutions to operate using both a payment system and an account management system. The payment system may process the individual payments or credits for submission to the account management system. The payment system can then bundle like transactions for the above-mentioned bundled transaction. In these systems, the bundling being performed in the payment system contributes to the problem. The account management system is primarily designed for processing the transactions including the ability to perform troubleshooting operations when problems arise. Using the two above-noted examples of overdraft and stop payments on a check, the account management system operates to process the payment and to ensure the functionality to prevent overdraft or stop payment transactions. Therefore, the existing systems are extremely limited in the ability to both bundle the payments and to prevent the erroneous processing of payments that cannot or should not be processed as part of a bundle.

### BRIEF DESCRIPTION OF THE DRAWINGS

FIG. 1 illustrates a block diagram of one embodiment of a payment processing system including a payment system in accordance with one embodiment of the present invention;

FIG. 2 illustrates a graphical representation of one embodiment of processing a financial transaction;

FIG. 3 illustrates a graphical representation of another embodiment of processing a financial transaction;

FIG. 4 illustrates a graphical representation of another embodiment of processing a financial transaction;

FIG. 5 illustrates a flowchart of the steps of one embodiment of a method of processing a financial transaction;

FIG. 6 illustrates a block diagram of one embodiment of a payment processing system; and

FIG. 7 illustrates a flowchart of the steps of one embodiment of the payment processing operations performed by the block diagram of FIG. 6.

### DETAILED DESCRIPTION

A payment system of a payment processing system includes additional functionality and the ability to perform additional operations allowing for single-entry batch processing within an account management system. Through the inclusion and operation of various pre-closing operations, the payment system can overcome the above-noted shortcomings associated with batch processing operations, including problems associated with processing unauthorized payments or payments that would exceed an account limit. Additionally, through the batch process, the account management system manages a single batched payment entry, thus reducing the number of account postings and administration concerns in the account management system.

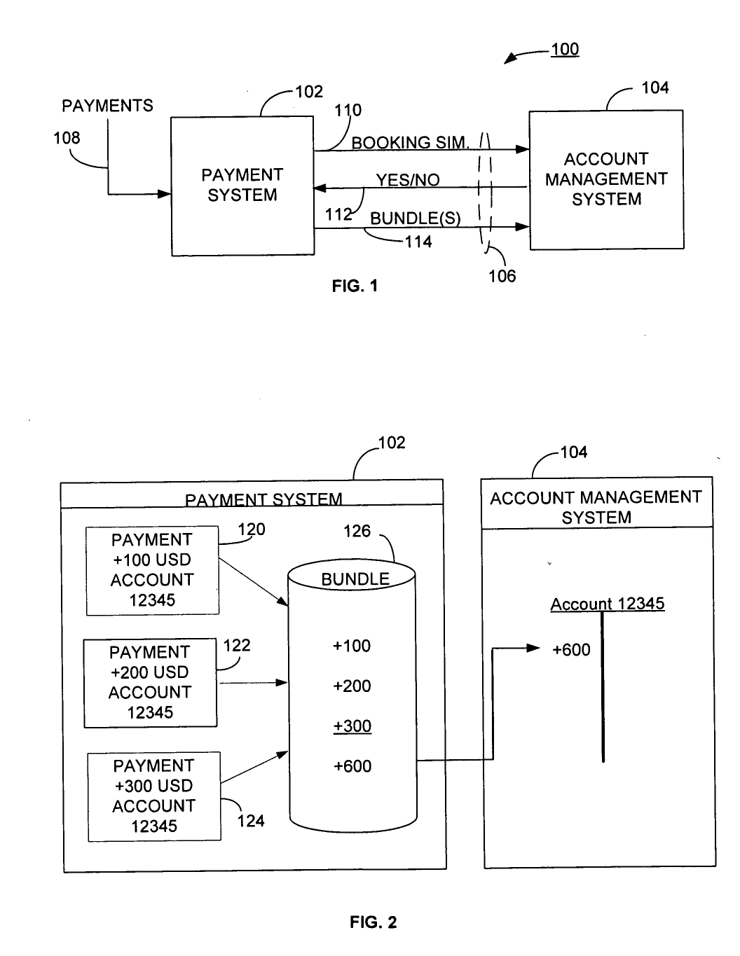

As illustrated in FIG. 1, a financial transaction processing system 100 includes a payment system 102 and an account management system 104. These systems 102 and 104 may be composed of one or more processing devices operative to perform executable operations in response to executable instructions. Additionally, the systems 102 and 104 may include one or more memory devices having the executable instructions, usable by the processing devices, stored therein.

In one embodiment, the payment system 102 and the account management system 104 may be incorporated within existing financial software packages. Additionally, these systems 102 and 104 may also be stand alone processing applications or processing devices. The systems 102 and 104 are in operative communication with each other across a connection, shown generally at 106. This connection may be a local physical connection, may be internal processing connections if the systems are incorporated on the same processing environment, the connection may be across a local area network, wide area network or any other type of networked connection.

In one embodiment, the payment system 102 receives data representing a plurality of payments 108. These payments 108 might be received from, for example, a clearing system (Automated Clearing House), from another banking application, from a lock box provider, from user entry or other suitable input sources. The payments 108 include, among additional information, a financial amount, an account identifier and an indication of whether the payment is a credit payment or a debit payment. In one embodiment, the credit payment is a positive amount indicating a credit is to be applied to the indicated account and the debit payment is a negative amount indicating a debenture amount to be withdrawn from the indicated account.

In one embodiment, the payment system 102 sorts the payments 108 by the payment type. If the payment is a credit payment, the credit payment is written to a credit bundle (not shown) associated with the indicated account. If the payment is a debit payment, the payment system 102 performs a booking simulation 110 with the account management system 104. The booking simulation 110 is similar to a normal booking operation with the account management system, except the account management system does not actually book or close the transaction. The simulation 110 allows the account management system 104 to simulate booking the transaction to determine if the debit payment would be accepted. For example, if the debit payment was a check and the payee has placed a stop payment on the check, the account management would detect if a stop payment is in place.

Based on this simulated booking 110, the account management system 104 provides a yes or no indicator 112 to the payment system 102. If the simulation 110 indicates the debit payment would be processed, the payment system 102 adds the debit payment into a debit bundle (not shown) associated with the indicated account. If the account management system 104 indicates, through the simulation 110, that the debit payment would not be accepted, the payment system 102 may sort the corresponding debit payment into a temporary buffer or choose to book the single debit payment on the account and let the account management system reject the payment.

Once all of the payments 108 have been processed, the payment system 102 may thereupon perform several bundle processing operations 114. A first bundle operation is to process the credit bundle. Processing the credit bundle first allows for the account management system to include the applicable credits before the debit bundle is processed.

In closing the debit bundle, the system 100 determines if the associated account has the financial reserves to cover the bundle transaction. In one embodiment, this may be performed by the payment system 102 communicating with the account management system 104 to verify the financial reserves of the associated account.

In the event the debit bundle would exceed the financial reserves, this would mean that if the bundle was processed, the account management system 104 would either have to reject the complete bundle or the underlying financial entity would have to extend credit to the payee to cover such overdraft. The payment system 102 is operative to remove debit payments until the bundle itself is below the financial reserves. In one embodiment, the payments are removed in a simple first in last out process.

Once the credit bundle is below the financial reserve, the payment system performs another bundle processing operation 114. In the account management system 104, the bundle may then be properly processed. In the account management system 114, the single bundle is listed as a debit entry, reducing accounting overhead. The bundle can also be processed with the assurance that the bundle does not include rejected or blocked payments and the processing of the bundle will not require the payee to be extended credit to a payee.

FIG. 2 illustrates a graphical representation of one embodiment of the payment system 102 and the account management system 104. In the payment system 102, three separate payments 120, 122 and 124 (which may be included in the illustrated payments 108 of FIG. 1 but have been explicitly individually designated for clarity purposes). Similar to the embodiment described above with respect to FIG. 1, the payments 120, 122 and 124 are processed and placed into a bundle 126, where the bundle may be one or more storage locations, or in another embodiment may be a designation indicating an association of the payments into a collective grouping.

As further illustrated in FIG. 2, the account management system 104 includes an account 12345. The payments 120, 122 and 124 received in the payment system 102 are credit payments, as indicated by the associated “+” dollar amount associated therewith.

In the embodiment of FIG. 2, the payment system 102 assembles the payments 120, 122 and 124 into the bundle 126 based on the associated account reference, which in this example is account 12345. As illustrated, the bundle now includes the credit amount of “+$600” based on the credits of $100 from payment 120, $200 from payment 122 and $300 from payment 124.

Through the payment system 102, the bundle 126 is provided in a single transaction to the account management system 104, as illustrated by the account entry of $600. In this embodiment, the account management system 104 thereupon logs the single $600 credit entry instead of three separate entries. It is also recognized that the payment system 102 operates with any suitable number of payments and as such the bundle may include hundreds, thousands or more credit entries provided as a single transaction to the account management system 104.

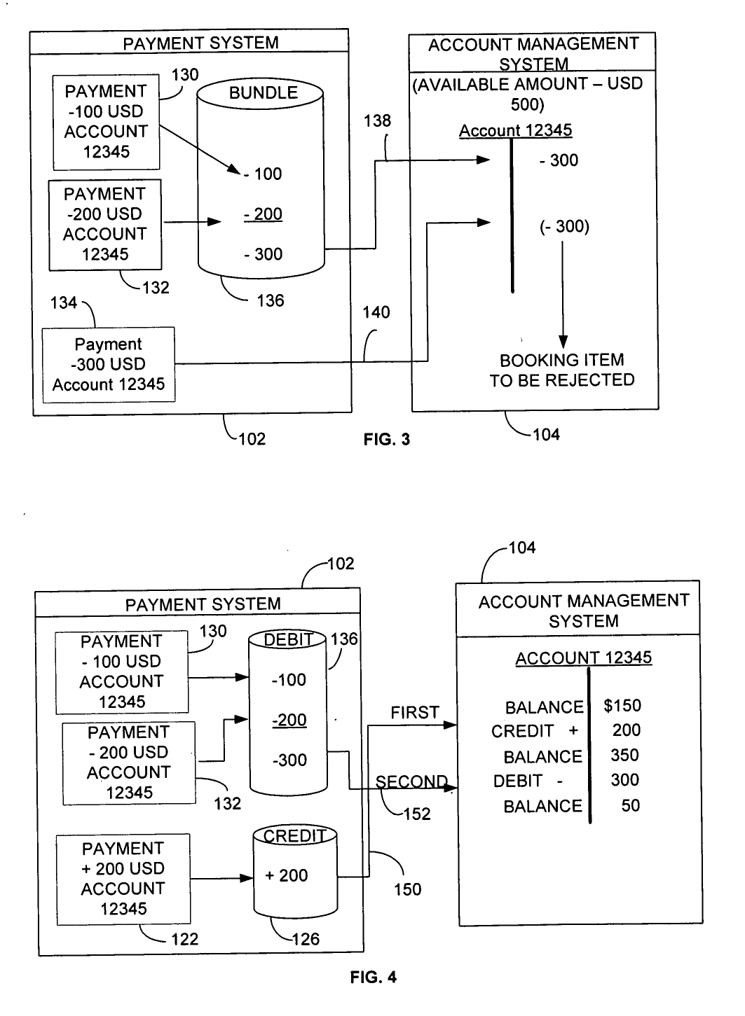

FIG. 3 illustrates another graphical illustration of an embodiment of the payment system 102 and the account management system 104. The payment system 102 receives the payments 130, 132 and 134. In this embodiment, the payments 130, 132 and 134 are debit payments, which may be recognized by the associated negative dollar amount. In addition to the debit amount, the payments 130, 132 and 134 also include associated account information, which in this example is again account 12345.

The account management system 104 includes the account information for account 12345 and indicates a starting balance of $500. Back in the payment system 102, the payments 130, 132 and 134 are provided to a debit bundle 136, which may be similar to the credit bundle 126 of FIG. 2. In this embodiment, only the first two payments 130 and 132 are included in the bundle because a comparison by the payment system 102 to the account management system 104 indicates the full bundle including the payment 134 would be in excess of the reserve amount in the account management system 104, which in this embodiment is $500.

Therefore, in this embodiment because the full combination of all payments 130, 132 and 134 (combined total of $600) exceeds the full reserve ($500) in the account management system 104, debit payments are removed until the bundle 136 includes a sum of payments below the account reserve. In this embodiment, a first in last out technique is utilized, therefore the payment 134 is removed from the bundle 136. Without payment 136, the bundle amount is $300 and can be processed 138 as a single transaction, leaving a remaining balance of $200 in the account. Then, the payment system 102 may separately process the third payment 134 so that payment may be properly rejected as exceeding the reserve.

FIG. 4 illustrates another graphical representation of an embodiment including the payment system 102 and the account management system 104. In this embodiment, the payment system 102 receives the payments 130, 132 and 122, which as described above include a $100 debit payment to account 12345 (payment 130), a $200 debit payment to account 12345 (payment 132) and a $200 credit payment to account 12345 (payment 122). The payment system 102 also includes the debit bundle 136 and the credit bundle 126.

In the account management system 104, account 12345 is illustrated as having a beginning balance of $150. In this embodiment, a first transaction 150 is processing the credit bundle 126. This thereupon insures the account has all applicable credits before processing any debit transactions. Thus, as illustrated in the account management system, the account is credited $200 giving a balance after the first transaction of $350.

The second processing step in this embodiment is to thereupon process 152 the debit bundle 136. Thus, the debit bundle amount of $300 is removed from the account, giving a remaining balance of $50. Had the order of the transactions been reversed, the debit bundle 136 would have been rejected as exceeding the reserve because the account balance without applicable credit would have been less than the debit bundle 136 amount. As with the other embodiments described above, the illustrated example shows three sample payments, but the payment system 102 is operative to process a significant volume of payments, thereby performing the above-described operations on any number of transactions and associated transaction values.

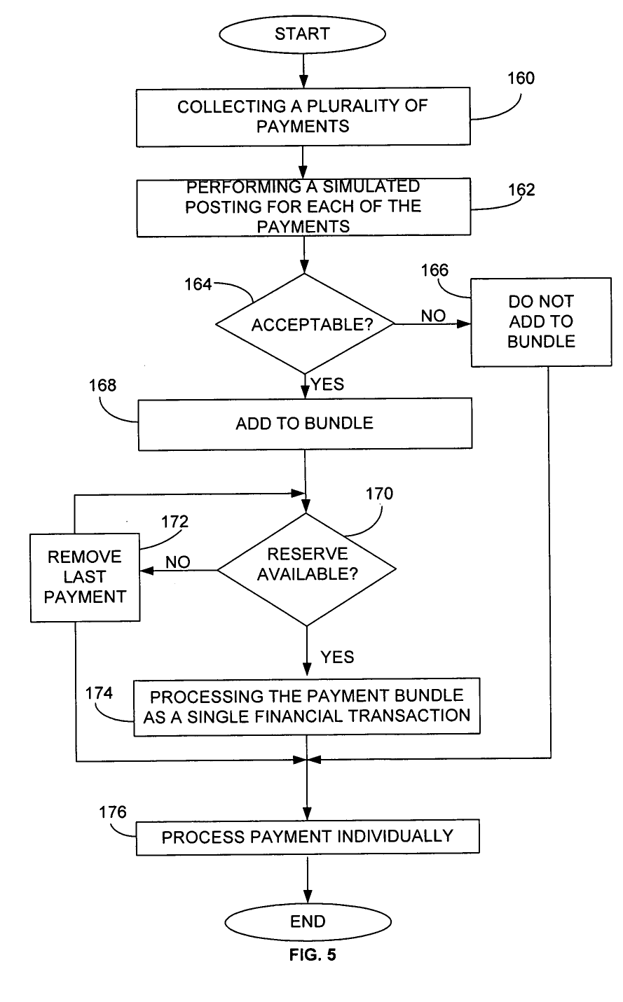

FIG. 5 illustrates a flowchart of the steps of one embodiment of a method for processing a financial transaction. In this embodiment, the first step, step 160, is collecting a plurality of payments. For example, these payments may be credit payments or debit payments and include, among other information, account and credit or debit amount information. For each of the debit payments, the next step, step 162 is performing a simulated posting in an account management system. This step includes a simulation identifier so that the account management system recognizes the transaction as a simulation and not an actual transaction to be recorded and processed in the system. This step may include the account management system performing an initial check on the debit payment to insure that the payment will be fully processed and not blocked or dishonored.

The next step, step 164, is to determine if the payment would have been accepted, based on the determination in step 162. If the payment would not have been accepted, this may indicate that a stop payment has been placed on the debit payment and it should not be included in a bundled transaction. Therefore, if the payment is not accepted, the next step is to not add the debit payment to the debit bundle, step 166. In one embodiment, as described in further detail below, the debit payment may be assigned to an individual processing bundle or other storage device as appropriate.

In the event the debit payment is acceptable, the next step, step 168 is to add the debit payment to the debit bundle. Steps 162-168 are repeated for all debit payments associated with the associated account. Thereupon, once all the payments have been processed for inclusion in or exclusion from the debit bundle, the next step, step 170 is to determine if the account in the account management system has enough reserves to the cover the debit bundle. If the reserve is not available, the next step, step 172, is to remove the last entered debit payment into the bundle. The process with regards to step 170 is repeated until the reserve is available, including continuing to remove debit payments from the debit bundle. Not specifically illustrated in the flow chart of FIG. 5, when payments are removed from the bundle in step 172, they may also be provided to the same storage location as the unacceptable payments as determined by step 164.

Once the reserve is available in step 170, the next step, step 174 is to process the payment bundle as single financial transaction. As described and illustrated above, this provides the processing of a single accounting transaction in the account management system. The next step, step 176, is to then process the individual payments that were either excluded from the bundle or included but later removed from the bundle. In this step, the account management system may then properly process the payments that are to be rejected. This then insures that the single transaction from the credit bundle is properly processed and the remaining transactions will not be improperly processed by the account management system. Thereupon, in this embodiment, the method is complete.

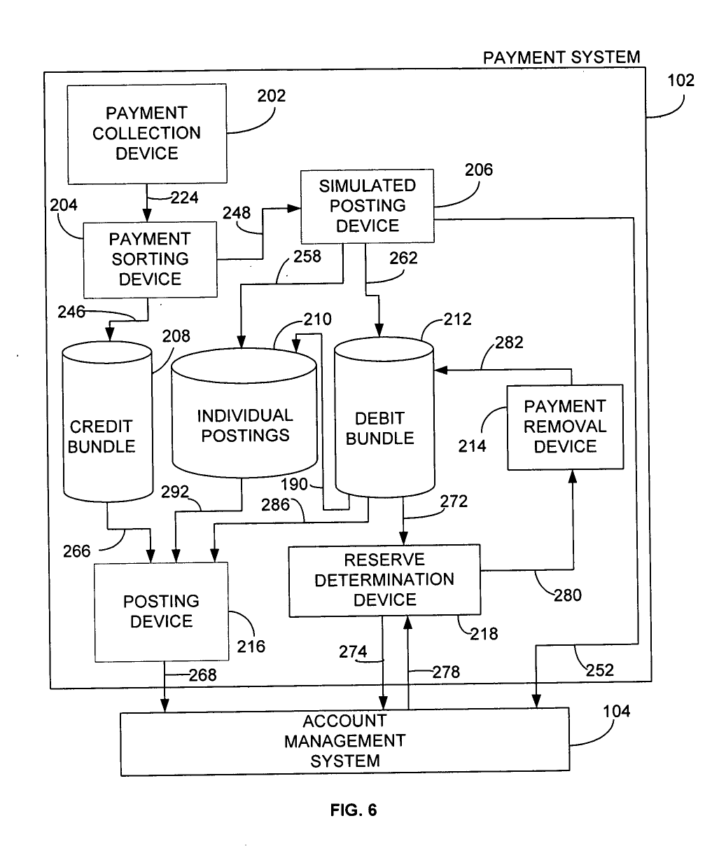

FIG. 6 illustrates a block diagram 200 of one embodiment of a payment system 102 and an account management system 104. The payment system 102 includes a payment collection device 202, a payment sorting device 204, a simulated posting device 206, a credit bundle 208, individual posting bundle 210, a debit bundle 212, a payment removal device 214, a posting device 216 and a reserve determination device 218. The devices 202, 204, 206, 214, 216 and 218 may be implemented in software or hardware including one or more processing devices operative to perform processing operations as described in further detail below. The bundles 208, 210 and 212 may be one or more storage devices operative to store payments as directed in the payment system 102.

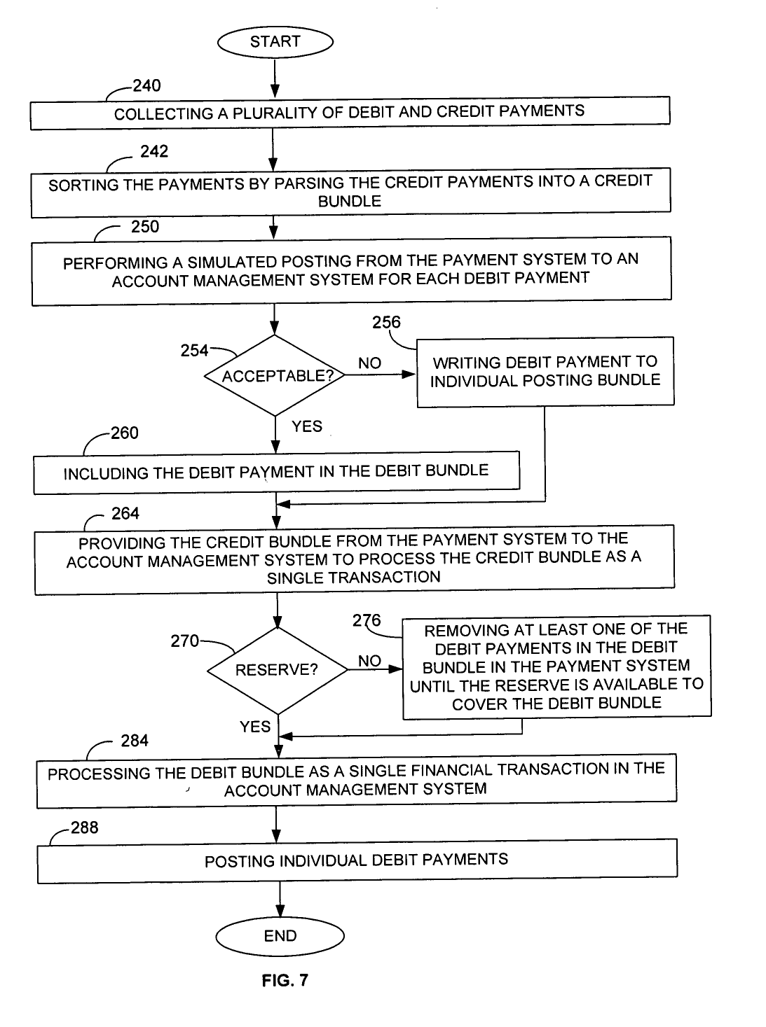

In one embodiment, the processing operations of the payment processing system of FIG. 6 is illustrated by the steps of the flowchart of FIG. 7, therefore for brevity sake, FIG. 6 will be discussed with reference to the flow chart of FIG. 7. In the method of FIG. 7, the first step, step 240, is collecting a plurality of credit and debit payments. In the payment system 102, the payment collection device 202 may collect these payments as they are received. The payment system 102 may perform closing operations with the account management system at preset timed intervals, for example at the close of a defined business day. The payments are received in the payment system 102 by being processed into a banking or other financial application, such as an accounting department physically entering the corresponding information or an automated system processing the received payments.

The next step, step 242, is sorting the payments by parsing the credit payments into a credit bundle. Referring back to FIG. 6, the payment collection device 202 provides the collected payments 244 to the payment sorting device 204. In the payment sorting device 204, the credit payments 246 are written to and stored in the credit bundle 208. The payment sorting device 204 also sorts the debit payments 248 and provides them to the simulated posting device 206.

The next step of the method, step 250, is performing a simulated posting from the payment system to the account management system for each debit payments. With reference to FIG. 6, the simulated posting device 206 performs a simulated posting 252 and receives an indication if the simulated posting would be accepted. As described above, the simulated posting 252 may include an indication for the account management system to simulate posting the debit payment, which would determine if there is a problem with the payment itself, such as a stop payment being in place. The account management system 104 may, in one embodiment, provide a simple yes or no indication of whether the simulated posting would be acceptable.

If the simulated posting is not acceptable, step 254, the next step is to write the debit payment to an individual posting bundle, step 256. As illustrated in FIG. 6, the simulated posting device 206 provides a rejected debit payment 258 to the individual posting bundle 210. If the debit payment is acceptable in step 254, the next step is to include the debit payment in the debit bundle, step 260. In FIG. 6, the simulated posting device 206 adds the accepted debit payment 262 to the debit bundle 212.

Whether the debit payment was written to the debit bundle or the individual posting bundle, the next step, step 264, is providing the credit payments in the credit bundle to the account management system so that the credit bundle is processed as a single transaction. In FIG. 6, the credit payments 266 collected in the credit bundle 208 are collectively provided to the posting device 216. The posting device 216, in accordance with normal operations, posts 268 the collective payments 266 as a single transaction to the account management system 104. It is recognized, as described above with respect to FIGS. 1-4, the credit bundle is associated with an identified account so the account management system 104 processes the credit to the corresponding account.

The next step, step 270, is to determine if the identified account in the account management system 104 includes an acceptable reserve to cover the debit bundle amount. As illustrated in FIG. 6, the reserve determination device 218 receives the debit bundle 272 which is a single collective debit entry of the debit payments in the debit bundle 212. The reserve determination device 218 compares 274 the debit bundle amount with an account reserve in the account management system 104. This may include a balance query by the reserve determination device 218 or other suitable techniques to verify the account balance prior to posting the debit bundle.

If the answer to step 270 is negative, the next step, step 276, is to remove debit payments until the account reserve can cover the debit bundle. In FIG. 6, the reserve determination device 218 receives a negative indication 278 from the account management system 104 indicating the debit bundle would not be processed without having to extend credit to the identified account. Therefore, the reserve determination device 218 provides a notification 280 to the payment removal device 214, which thereupon instructs 282 the removal of a debit payment from the bundle 212. This process is repeated until the debit bundle does not exceed the account reserve. The removed debit payment 290 may also be provided to the individual posting bundle 210.

If the reserve is not met, either through decision step 270 or through the removal step of 276, the next step, step 284 is to process the debit bundle as a single financial transaction in the account management system. In the payment system 102 of FIG. 6, the bundled debit payments 286 are provided from the debit bundle 212 to the posting device 216 and posted 268 as a single transaction in the account management system 104. Based on the steps 254, 270 and/or 276, the account management system 104 will be able to properly process the bundled payment as a single transaction without processing any rejected payments or payments that would exceed the account reserve.

The next step, step 288, is posting the individual debit payments to the account management system 104. As illustrated in FIG. 6, the individual postings bundle includes the debit payments 258 indicated as rejected by the simulated posting device 206 and the debit payments 290 removed from the debit bundle based on instructions 282 from the payment removal device 214. The individual postings 292 are then provided to the posting device 216 and posted 268 the account management system 104. As previously identified by the payment system, these individual postings 292 will most likely be rejected in the account management system 104. Thereupon, the method is complete.

Through the above-described operations, the payment system allows pre-processing operations to facilitate proper batch processing of payments. The pre-processing operations allow for the detection of payments that would be rejected and payments which would cause the account management system to exceed an account reserve. Through these operations, the payment system may then effectively insure the batch processing operations will result in the batched transaction being accepted in the account management system. Additionally, the system allows for the follow-up processing of the troubled payments such that the account management may effectively process all payments and handle the blocked or overdraft transactions separate from the bundled transaction. The assurance of a properly processed bundled transaction further allows for the reduction in the overhead of the account management system as the batch processes are insured to be properly processed and can reduce the number of account transactions for multiple payment processing.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A financial transaction processing method comprising:
collecting a plurality of payments;
performing a simulated posting for each of the payments;
for each of the plurality of payments, if the simulated posting is acceptable, bundling the payment into a payment bundle;
determining if a reserve is available to cover the payment bundle; and
if the reserve is available, processing the payment bundle as a single financial transaction.

2. The method of claim 1, wherein the payment bundle is a debit bundle, the step of performing the simulated posting further comprising:
confirming a debit account will accept the debit payment.

3. The method of claim 2 further comprising:
if the reserve is not available, removing at least one of the plurality of payments until the reserve is available to cover the payment bundle.

4. The method of claim 3 wherein the payments are removed in a first in last out manner.

5. The method of claim 1, wherein the plurality of payments include at least one of a debit payment and a credit payment, the method further comprising:
bundling the plurality of debit payments into a debit bundle; and
bundling the plurality of credit payments into a credit bundle.

6. The method of claim 5 further comprising:
processing the credit bundle; and
determining if the system reserve is available to cover the debit bundle where the system reserve includes credit based on the credit bundle.

7. A financial transaction processing apparatus comprising:
a memory device storing executable instructions; and
a processing device, in response to the executable instructions, operative to:
collect a plurality of payments;
perform a simulated posting for each of the payments;
for each of the plurality of payments, if the simulated posting is acceptable, bundle the payment into a payment bundle;
determine if a reserve is available to cover the payment bundle; and
if the reserve is available, process the payment bundle as a single financial transaction.

8. The apparatus of claim 7, wherein the payment bundle is a debit bundle, the processing device, when performing the simulated posting if further operative to:
confirm a debit account will accept the debit payment.

9. The apparatus of claim 7 wherein the processing device is further operative to:
if the reserve is not available, remove at least one of the plurality of payments until the reserve is available to cover the payment bundle.

10. The apparatus of claim 9 wherein the payments are removed in a first in last out manner.

11. The apparatus of claim 8, wherein the plurality of payments include at least one of a debit payment and a credit payment, the processing device further operative to:
bundle the plurality of debit payments into a debit bundle; and
bundle the plurality of credit payments into a credit bundle.

12. The apparatus of claim 11, the processing device further operative to:
process the credit bundle; and
determine if the system reserve is available to cover the debit bundle where the system reserve includes credit based on the credit bundle.

13. A method for batch processing a financial transaction, the method comprising:
collecting a plurality of payments in a payment system, where the payments include debit payments and credit payments;
sorting the payments by parsing debit payments into a debit bundle and the credit payments into a credit bundle, wherein for at least one of the debit payments of the debit bundle, performing a simulated posting from the payment system to an account management system prior to inclusion in the debit bundle;
if the simulated posting is acceptable by the account management system, including the debit payment in the credit bundle
providing the credit bundle from the payment system to the account management system to process the credit bundle as a single transaction in the account management system;
determining if a reserve is available in the account management system to cover the credit bundle; and
if the reserve is available, processing the credit bundle as a single financial transaction in the account management system.

14. The method of claim 13, wherein the step of performing the simulated posting further comprising:
confirming a payment account will accept the debit payment.

15. The method of claim 13 further comprising:
if the reserve is not available, removing at least one of the debit payments in the debit bundle in the payment system until the reserve is available to cover the debit bundle.

16. The method of claim 15 wherein the debit payments are removed in a first in last out manner.

17. The method of claim 13 further comprising:
for each of the debit payments where the simulated posting of the debit payment is not acceptable by the account management system, posting the debit payment to the account management system separate from the debit bundle.

18. A payment system comprising:
a payment collection device operative to collect a plurality of payments, where the payments include debit payments and credit payments;
a payment sorting device operative to sort the payments by parsing debit payments into a debit bundle and the credit payments into a credit bundle;
a simulated posting device operative to perform a simulated posting of each of the debit payments with an account management system prior to inclusion in the debit bundle such that if the simulated posting is acceptable by the account management system, the payment sorting device includes the debit payment in the credit bundle
a posting device operative to post the credit bundle to the account management system as a single transaction; and
a reserve determination device operative to determine if a reserve is available in the account management system to cover the credit bundle such that if the reserve is available, the posting device is further operative to post the credit bundle to the account management system as a single financial transaction.

19. The payment system of claim 18, wherein the simulated posting device is operative to confirm a payment account will accept the debit payment.

20. The payment system of claim 18 further comprising:
a payment removal device operative to, if the reserve is not available, remove at least one of the debit payments in the debit bundle in the payment system until the reserve is available to cover the debit bundle.

21. The payment system of claim 20 wherein the debit payments are removed in a first in last out manner.

22. The payment system of claim 18, wherein the posting device is further operative to, for each of the debit payments where the simulated posting of the debit payment is not accepted by the account management system, post the debit payments to the account management system separate from the debit bundle.

23. An automated payment processing method, comprising, for each of a plurality of payment process requests:
aggregating debenture terms of the payment process requests, generating an aggregate debenture therefrom,
querying an accounts management system to determine if the system holds actual account reserves sufficient to cover the aggregate debenture, and
if not, removing debenture terms of select ones of the payment process requests from the aggregate debenture and repeating the querying until the actual account reserves are sufficient to cover a final aggregate debenture obtained therefrom, and
committing the final aggregate debenture to the accounts management system.

24. The automated method of claim 23, further comprising, prior to the aggregating, performing a simulated booking of payment process requests upon the accounts management system and barring from the aggregating select payment process requests that are identified as invalid based on the simulated booking.

25. The automated method of claim 23, wherein the committing records the debenture as a single line item in the accounts management system.
